(19) United States
(12) Patent Application Publication
(10) Pub. No.: US 2018/0233735 A1
(43) Pub. Date: Aug. 16, 2018

(54) METHOD FOR PRODUCING NEGATIVE ELECTRODE FOR LITHIUM ION SECONDARY BATTERIES

(71) Applicant: NEC ENERGY DEVICES, LTD., Sagamihara-shi, Kanagawa (JP)

(72) Inventor: Yasutaka KONO, Kanagawa (JP)

(73) Assignee: NEC ENERGY DEVICES, LTD., Sagamihara-shi, Kanagawa (JP)

(21) Appl. No.: 15/751,055

(22) PCT Filed: Sep. 14, 2016
(86) PCT No.: PCT/JP2016/077057

§ 371 Date: Feb. 7, 2018

(30) Foreign Application Priority Data
Sep. 28, 2015 (JP) 2015-189916

(51) Int. Cl. H01M 4/1393; H01M 10/0525; H01M 4/133; H01M 4/131; H01M 4/137; H01M 4/1391; H01M 4/04; H01M 4/66; H01M 4/62

(52) U.S. Cl. CPC H01M 4/1393; H01M 10/0525; H01M 4/133; H01M 4/131; H01M 4/622; H01M 4/1391; H01M 4/0404; H01M 4/661; H01M 4/137

(57) ABSTRACT

A method for producing a negative electrode for a lithium ion secondary battery, the negative electrode comprising a current collector, and a negative electrode active material layer disposed on the current collector, the method comprises: preparing a slurry comprising a negative electrode active material, a binder, a water-soluble polymeric thickener, and an aqueous solvent; and forming a coating layer to be used as the negative electrode active material layer by applying the slurry on the current collector and drying the slurry for removing the aqueous solvent, and the preparing a slurry comprises: preparing a dispersion comprising the water-soluble polymeric thickener dissolved and an acrylic binder dispersed; and preparing and stirring a mixture comprising a powder material comprising the negative electrode active material, and the dispersion.

### TECHNICAL FIELD

The present invention relates to a method for producing a negative electrode for a lithium ion secondary battery.

### BACKGROUND ART

Lithium ion secondary batteries, since being high in the energy density and excellent in the charge and discharge cycle characteristics, are broadly used as power sources for small-size mobile devices such as cell phones and laptop computers. Further in recent years, in consideration of environmental problems and in growing concern for energy saving, there have been raised demands for large-size power sources required to have a high capacity and a long life, including vehicular power storage batteries for cars such as electric cars and hybrid electric cars, and power storage systems such as household power storage systems.

Various studies for negative electrode are under way in order to improve characteristics of and production methods for lithium ion secondary batteries.

Patent Literature 1 describes a method for producing an electrode plate for a negative electrode of a nonaqueous secondary battery using a paste produced by kneading/dispersing a carbon material containing graphite as a main agent, a thickener and a binder. It is described that carboxymethyl cellulose is used as the thickener, and that a water-dispersible polymer having a polar group (a core-shell rubber particle type binder containing an acrylonitrile unit) is used as the binder. This production method is described to include at least three steps of an initial kneading step of kneading a mixture of graphite and an aqueous solution of the thickener, a dilution kneading step of diluting a kneaded product obtained in the initial kneading step with an aqueous solution of the thickener and kneading the resultant, and a finish kneading step of preparing a paste by adding the binder to a kneaded product of the dilution kneading step and kneading the resultant.

Patent Literature 2 discloses a method for producing a negative electrode mixture for a nonaqueous secondary battery including kneading/dispersing a negative electrode active material, a conductive agent and a dispersion in which a binder is dispersed in a thickener solution. Specifically, a fluorine resin (polyvinylidene fluoride) is used as the binder, carboxymethyl cellulose is used as the thickener, SiSnO₃ is used as the negative electrode active material, and acetylene black and graphite are used as the conductive agent in an example described therein. It is further described that when this production method is employed, the amount of aggregates such as aggregates of the binder contained in the negative electrode mixture and carbon aggregates can be reduced without lowering the viscosity of the negative electrode mixture, resulting in elongating the lifetime characteristic of the secondary battery to be produced.

Patent Literature 3 discloses a slurry to be used for forming a negative electrode coating film of a lithium ion secondary battery containing a carbon material as a negative electrode active material, a hydrate mixture of an acrylic copolymer (aqueous emulsion) and carboxymethyl cellulose as a binder, and an aqueous medium. Specifically, an emulsion of an acrylic-styrene copolymer and a carboxymethyl cellulose ammonium salt are used in an example described therein. It is described that a negative electrode coating film for a battery formed by using this slurry is excellent in adhesiveness between carbon particles and between a carbon particle and a current collector, has a high discharge capacity, and is excellent in cycle life characteristic.

### CITATION LIST

### Patent Literature

Patent Literature 1: JP2006-92760A

Patent Literature 2: JP08-195201A

Patent Literature 3: JP2000-294230A

### SUMMARY OF INVENTION

### Technical Problem

An object of the present invention is to provide a production method capable of producing, with high productivity, a negative electrode including a negative electrode active material layer excellent in adhesiveness to a current collector and in a binding property between active material particles.

### Solution to Problem

According to one aspect of the present invention:

there is provided a method for producing a negative electrode for a lithium ion secondary battery, the negative electrode comprising a current collector, and a negative electrode active material layer disposed on the current collector, the method comprising:

preparing a slurry comprising a negative electrode active material, a binder, a water-soluble polymeric thickener, and an aqueous solvent; and

forming a coating layer to be used as the negative electrode active material layer by applying the slurry on the current collector, and drying the slurry for removing the aqueous solvent,

wherein said preparing the slurry comprises:

preparing a dispersion comprising the water-soluble polymeric thickener dissolved in the aqueous solvent and an acrylic binder dispersed as the binder; and

preparing and stirring a mixture comprising a powder material comprising the negative electrode active material, and the dispersion.

### Advantageous Effects of Invention

According to the exemplary embodiment, a production method capable of producing, with high productivity, a negative electrode including a negative electrode active material layer excellent in adhesiveness to a current collector and in a binding property between active material particles can be provided.

### BRIEF DESCRIPTION OF DRAWING

FIG. 1 is a cross-sectional view illustrating an example of a lithium ion secondary battery including a negative electrode according to the exemplary embodiment.

### DESCRIPTION OF EMBODIMENT

A method for producing a negative electrode for a lithium ion secondary battery according to the exemplary embodiment includes: a step of preparing a slurry containing a negative electrode active material, a binder, a water-soluble polymeric thickener (for example, carboxymethyl cellulose, which is hereinafter designated as “CMC”), and an aqueous solvent (for example, water); and a step of forming a coating film to be used as a negative electrode active material layer by applying the slurry on a current collector, and drying the applied slurry. The step of preparing a slurry includes: a step of preparing a dispersion in which the water-soluble polymeric thickener is dissolved in the aqueous solvent and an acrylic binder is dispersed; and a step of preparing and stirring a mixture containing a powder material containing a negative electrode active material, and the dispersion. This mixture may further contain another aqueous solvent or additive if necessary. The powder material can contain another powder material such as a conductive auxiliary agent.

According to this production method, a time required for the production process (particularly, the step of preparing a slurry) can be shortened, and in addition, an electrode including a negative electrode active material layer excellent in adhesiveness to a current collector and in a binding property between active material particles can be produced.

In this production method, the step of preparing a slurry preferably includes a step of preparing a first dispersion in which an acrylic binder is dispersed in the aqueous solvent, a step of preparing, by adding the water-soluble polymeric thickener to the first dispersion, a second dispersion in which the water-soluble polymeric thickener is dissolved in the aqueous solvent, and a step of preparing and stirring a mixture containing the powder material containing the negative electrode active material, and the second dispersion.

As compared with the production method of the exemplary embodiment, in employing a method in which a powder material containing a negative electrode active material is precedently mixed with an aqueous solution of a water-soluble polymeric thickener, a binder is then added to the thus obtained mixture, and the resultant is stirred, a time for sufficiently mixing the binder added afterward is excessively necessary. Besides, mechanical shear is applied to the binder during the stirring after mixing, which tends to degrade the binder function.

Alternatively, if a binder (particularly, a rubber-based binder such as SBR (styrene-butadiene rubber)) is precedently added to a CMC aqueous solution to prepare a binder dispersion, and the binder dispersion and a powder material containing a negative electrode active material are mixed and stirred, mechanical shear is applied to the binder during the stirring, which tends to largely degrade the binder function.

In the production method of the exemplary embodiment, the acrylic binder is used as the binder, and the binder dispersion containing the binder and the thickener is prepared, and then the binder dispersion and the powder material (containing the negative electrode active material) are mixed and stirred. Therefore, the time for preparing the slurry can be shortened, and in addition, the degradation of the binder function otherwise caused by mechanical shear during the stirring can be inhibited. As a result, a negative electrode including a negative electrode active material layer excellent in the adhesiveness to a current collector and in the binding property between active material particles can be produced with high productivity.

Besides, it is preferable that the binder (the acrylic binder) is added to and dispersed in the aqueous solvent beforehand and then, the water-soluble polymeric thickener (for example, CMC) is added thereto and dissolved therein. Thus, the dispersion in which the binder is homogeneously dispersed can be easily prepared, the time required for preparing the dispersion can be shortened, and the degradation of the binder function otherwise caused by the mechanical shear during the stirring can be inhibited. Since a CMC aqueous solution is viscous, if the binder is added to such a viscous CMC aqueous solution and the resultant is stirred, there is a tendency that a long time may be required for homogeneously dispersing the binder, or that the binder function may be degraded because mechanical shear is applied to the binder during the stirring. When the binder is added to and dispersed in the aqueous solvent, and then the water-soluble polymeric thickener is added thereto and dissolved therein, the time required for homogeneous dispersion can be shortened, and the degradation of the binder function can be inhibited.

The step of preparing a slurry will now be described in detail.

First, the acrylic binder and the aqueous solvent (for example, water) are mixed to prepare the first dispersion in which the acrylic binder is dispersed.

An example of the acrylic binder includes a homopolymer or a copolymer containing a unit of acrylic acid, methacrylic acid, or an ester or salt thereof (hereinafter referred to as the “acrylic unit”). Examples of the copolymer include a copolymer containing an acrylic unit and a styrene unit, and a copolymer containing an acrylic unit and a silicone unit. If the acrylic binder contains a styrene unit, the binding property between active material particles can be increased. As the acrylic binder, one prepared in the form of an aqueous emulsion can be used. The acrylic binder preferably contains a surfactant or a dispersant, and may be the same one as that used in polymerization. Examples of the surfactant to be contained in the acrylic binder include an anionic surfactant and a nonionic surfactant, and at least one of these is preferably contained.

The content of the acrylic binder can be in the range of 0.5 to 5% by mass with respect to the aqueous solvent, and preferably 1 to 3% by mass. If the content of the binder is too small, a sufficient binding effect cannot be attained. On the contrary, if the content is too large, homogeneous dispersion may be difficult, or the electrical resistance of the negative electrode active material layer may become large.

Next, the water-soluble polymeric thickener is added to the first dispersion to prepare the second dispersion in which the water-soluble polymeric thickener is dissolved. The water-soluble polymeric thickener may be added in the form of a solid such as a powder, or may be added in the form of an aqueous solution, and is preferably added in the form of a solid such as a powder to be dissolved therein from the viewpoint of workability and homogeneity.

Examples of the water-soluble polymeric thickener include a cellulose derivative, polyvinyl alcohol or a modified product thereof, starch or a modified product thereof, polyvinyl pyrrolidone, polyacrylic acid or a salt thereof, and polyethylene glycol. Among these, a cellulose derivative is preferred, and carboxymethyl cellulose (CMC) is more preferred.

As the CMC, a sodium salt or ammonium salt thereof can be used, and a sodium salt is preferably used. The CMC sodium salt increases the viscosity of a resultant CMC solution at the same concentration than the CMC ammonium salt, and can improve dispersibility of the active material particles in the slurry by addition of a comparatively small amount. Besides, if the CMC ammonium salt is used, it is apprehended that facilities used may be corroded or the like by alkali vapor generated in drying after applying the slurry, but if the CMC sodium salt is used, such a problem does not arise and the CMC sodium salt is easily handled during the production.

The content of the water-soluble polymeric thickener can be set to the range of 0.5 to 5% by mass with respect to the aqueous solvent, and is preferably 1 to 5% by mass.

Next, the second dispersion and the powder material containing the negative electrode active material are mixed, and the resultant is stirred. This mixing step is preferably performed in two steps with the concentration of the mixture changed.

In the first step, the powder material and the second dispersion are mixed and kneaded so that a solid concentration of the resultant mixture can be 50% by mass or higher and 70% by mass or lower. The solid concentration of the mixture is more preferably 55% by mass or higher and 65% by mass or lower. If the stirring (kneading) is performed in this concentration range, these components can be more homogeneously mixed. In particular, homogeneity in dispersion of the conductive auxiliary agent around the active material particles can be improved. Here, the solid concentration of the mixture refers to a mass ratio (in a percentage) of a solid component to a sum of the aqueous solvent (for example, water) and the solid component excluding the aqueous solvent (that is, materials used for forming the active material layer, i.e., the active material, the conductive auxiliary agent, the CMC, and the binder).

In the subsequent second step, the stirring is performed with the solid concentration lowered so that the solid concentration of the mixture (the slurry) can be 40% by mass or higher and lower than 50% by mass. The solid concentration of the mixture (the slurry) is preferably 45% by mass or higher, and 48% by mass or lower. When such a concentration range is set, a good application property of the slurry can be attained. Besides, if the concentration of the powder material is sufficiently high, the amount of the solvent to be removed by drying can be suppressed, and hence, energy cost can be reduced.

In the second step, as a method for lowering the solid concentration, water can be added as an aqueous solvent, and instead of water, an aqueous solution of a water-soluble polymeric thickener or another additive dissolved in water may be used.

Now, a production method for a negative electrode according to the exemplary embodiment, a negative electrode produced by the production method, and a lithium ion secondary battery using the negative electrode will be further described.

(Lithium Ion Secondary Battery)

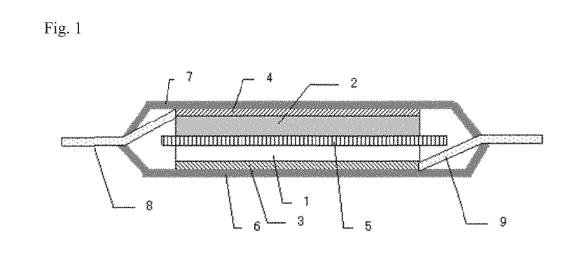

A cross-sectional view of one example (laminate-type) of the lithium ion secondary battery according to the exemplary embodiment is shown in FIG. 1. As shown in FIG. 1, the lithium ion secondary battery of the present example has a positive electrode comprising a positive electrode current collector 3 composed of a metal such as an aluminum foil and a positive electrode active material layer 1 containing a positive electrode active material provided thereon, and a negative electrode comprising a negative electrode current collector 4 composed of a metal such as a copper foil and a negative electrode active material layer 2 containing a negative electrode active material provided thereon. The positive electrode and the negative electrode are laminated through a separator 5 composed of a nonwoven fabric, a polypropylene microporous membrane or the like so that the positive electrode active material layer 1 and the negative electrode active material layer 2 face each other. The pair of electrodes is accommodated in a container formed of outer packages 6, 7 composed of an aluminum laminate film. A positive electrode tab 9 is connected to the positive electrode current collector 3, and a negative electrode tab 8 is connected to the negative electrode current collector 4. These tabs are led outside the container. The electrolyte solution is injected in the container, which is then sealed. There may be made a structure in which an electrode group in which a plurality of electrode pairs are laminated is accommodated in the container.

(Negative Electrode)

As the negative electrode active material, a carbonaceous material can be used. Examples of the carbonaceous material include graphite, amorphous carbon (for example, graphitizable carbon or non-graphitizable carbon), diamond-like carbon, fullerene, a carbon nanotube and a carbon nanohorn. As the graphite, natural graphite or artificial graphite can be used, and from the viewpoint of the material cost, inexpensive natural graphite is preferable. Examples of the amorphous carbon include heat-treated products of coal pitch coke, petroleum pitch coke, acetylene pitch coke and the like.

The average particle diameter of the negative electrode active material is, from the viewpoint of suppressing a side-reaction during the charge and discharge and thereby suppressing decrease in the charge and discharge efficiency, preferably 2 μm or larger, more preferably 5 μm or larger, and from the viewpoint of the input and output characteristics and the viewpoint of the electrode fabrication (smoothness of the electrode surface, and the like), preferably 40 μm or smaller, and more preferably 30 μm or smaller. Here, the average particle diameter means a particle diameter (median diameter: D₅₀) at a cumulative value of 50% in a particle size distribution (in terms of volume) by a laser diffraction scattering method.

With respect to the fabrication of the negative electrode, the negative electrode (the current collector, and the negative electrode active material layer thereon) can be obtained by applying, on the negative electrode current collector, the slurry containing the negative electrode active material, the binder, the water-soluble polymeric thickener, the aqueous solvent, and as required, the conductive auxiliary agent, and drying the slurry, and as required, pressing the dried slurry to form the negative electrode active material layer. Examples of a method for applying the negative electrode slurry include a doctor blade method, a die coater method and a dip coating method. To the slurry, as required, additives such as a defoaming agent and a surfactant may be added.

The content of the binder in the negative electrode active material layer is, from the viewpoint of the binding power and the energy density, which are in a tradeoff relation, in terms of content with respect to the negative electrode active material layer, preferably in the range of 0.5 to 15% by mass, more preferably in the range of 0.5 to 10% by mass, and still more preferably in the range of 1 to 10% by mass.

The content of the water-soluble polymeric thickener in the negative electrode active material layer is, in terms of content with respect to the negative electrode active material layer, preferably in the range of 0.2 to 10% by mass, more preferably in the range of 0.5 to 5% by mass, and still more preferably in the range of 0.5 to 2% by mass. The content of this thickener is, from the viewpoint of the electrical resistance of the negative electrode active material layer, preferably 10% by mass or smaller, and from the viewpoint of improving the dispersibility and the adhesiveness of the active material particles to attain sufficient biding power, preferably 0.2% by mass or larger.

The negative electrode active layer may contain a conductive auxiliary agent, as required. As the conductive auxiliary agent, there can be used conductive materials generally used as conductive auxiliary agents for negative electrodes, such as carbonaceous materials such as carbon black, Ketjen black and acetylene black. The content of the conductive auxiliary agent in the negative electrode active material layer is, in terms of content with respect to the negative electrode active material, preferably in the range of 0.1 to 3.0% by mass. The content of the conductive auxiliary agent with respect to the negative electrode active material is, from the viewpoint of forming a sufficient conduction path, preferably 0.1% by mass or higher, and more preferably 0.3% by mass or higher, and from the point of suppressing the gas generation due to the decomposition of an electrolyte solution and a decrease in the exfoliation strength that are caused by excessive addition of the conductive auxiliary agent, preferably 3.0% by mass or lower, and more preferably 1.0% by mass or lower.

The average particle diameter (the primary particle diameter) of the conductive auxiliary agent is preferably in the range of 10 to 100 nm. The average particle diameter (the primary particle diameter) of the conductive auxiliary agent is, from the viewpoint of inhibiting excessive aggregation of the conductive auxiliary agent to attain homogeneous dispersion in the negative electrode, preferably 10 nm or larger, and more preferably 30 nm or larger, and from the viewpoint of forming a good conduction path by forming a sufficient number of contact points, is preferably 100 nm or smaller, and more preferably 80 nm or smaller. If the conductive auxiliary agent is fibrous, a fiber having an average diameter of 2 to 200 nm and an average fiber length of 0.1 to 20 μm may be used.

Here, the average particle diameter of the conductive auxiliary agent refers to a median diameter (D₅₀), and means a particle diameter at a cumulative value of 50% in a particle size distribution (in terms of volume) by the laser diffraction scattering method.

As the negative electrode current collector, copper, stainless steel, nickel, titanium or an alloy thereof can be used. Examples of the shape thereof include a foil, a flat plate and a mesh.

(Positive Electrode)

A positive electrode active material is not especially limited, and for example, a lithium composite oxide having a layered rock salt structure or a spinel structure, or lithium iron phosphate having an olivine structure can be used. Examples of the lithium composite oxide include lithium manganate (LiMn₂O₄); lithium cobaltate (LiCoO₂); lithium nickelate (LiNiO₂); compounds obtained by substituting at least a part of a manganese, cobalt, or nickel portion of these lithium compounds with another metal element such as aluminum, magnesium, titanium or zinc; nickel-substituted lithium manganate obtained by substituting at least a part of manganese of lithium manganate with nickel; cobalt-substituted lithium nickelate obtained by substituting at least a part of nickel of lithium nickelate with cobalt; compounds obtained by substituting a part of manganese of nickel-substituted lithium manganate with another metal (such as at least one of aluminum, magnesium, titanium and zinc); and compounds obtained by substituting a part of nickel of cobalt-substituted lithium nickelate with another metal element (such as at least one of aluminum, magnesium, titanium, zinc and manganese). One of these lithium composite oxides may be used singly, or a mixture of two or more of these may be used.

An example of a lithium-containing composite oxide having a layered crystal structure includes a lithium nickel-containing composite oxide. As the lithium nickel-containing composite oxide, one in which a part of nickel on the nickel sites is substituted with another metal can be used. The metal other than Ni occupying the nickel sites is at least one metal selected from, for example, Mn, Co, Al, Mg, Fe, Cr, Ti and In.

The lithium nickel-containing composite oxide preferably comprises Co as a metal other than Ni occupying the nickel sites. Further the lithium nickel-containing composite oxide more preferably comprises, in addition to Co, Mn or Al, that is, there can suitably be used a lithium nickel cobalt manganese composite oxide having a layered crystal structure (NCM), a lithium nickel cobalt aluminum composite oxide having a layered crystal structure (NCA), or a mixture thereof.

As the lithium nickel-containing composite oxide having a layered crystal structure, one represented by the following formula can be used, for example.

Li₁₊ₐ(Ni_{b}Co_{c}Me1_{d}Me2_{1-b-c-d})O₂

wherein Me1 is Mn or Al; Me2 is at least one (excluding the same metal as Me1) selected from the group consisting of Mn, Al, Mg, Fe, Cr, Ti and In; and −0.5≤a<0.1, 0.1≤b<1, 0<c<0.5, and 0<d<0.5.

The average particle diameter of the positive electrode active material is, from the viewpoint of the reactivity with an electrolyte solution, the rate characteristics and the like, for example, preferably 0.1 to 50 μm, more preferably 1 to 30 μm, and still more preferably 2 to 25 μm. Here, the average particle diameter means a particle diameter (median diameter: D₅₀) at a cumulative value of 50% in a particle size distribution (in terms of volume) by a laser diffraction scattering method.

The positive electrode is constituted of a positive electrode current collector, and a positive electrode active material layer on the positive electrode current collector. The positive electrode is disposed so that the active material layer faces a negative electrode active material layer on a negative electrode current collector through a separator.

The positive electrode active material layer can be formed as follows. The positive electrode active material layer can be formed by first preparing a slurry containing the positive electrode active material, a binder and a solvent (as required, further a conductive auxiliary agent), applying and drying the slurry on the positive electrode current collector, and as required, pressing the dried slurry. As the slurry solvent to be used in the positive electrode fabrication, N-methyl-2-pyrrolidone (NMP) can be used.

The positive electrode active material layer can contain a conductive auxiliary agent in addition to the positive electrode active material and the binder. The conductive auxiliary agent is not especially limited, and any of conductive materials to be usually used as conductive auxiliary agents for positive electrodes, such as carbonaceous materials such as carbon black, acetylene black, natural graphite, artificial graphite, and carbon fibers, can be used.

As the binder, any of binders to be usually used for positive electrodes, such as polytetrafluoroethylene (PTFE) and polyvinylidene fluoride (PVDF) can be used.

Although a higher proportion of the positive electrode active material in the positive electrode active material layer is better because the capacity per mass becomes larger, addition of a conductive auxiliary agent is preferable from the point of reduction of the electrode resistance of the electrode; and addition of a binder is preferable from the point of the electrode strength. A too low proportion of the conductive auxiliary agent makes it difficult for a sufficient conductivity to be kept, and becomes liable to lead to an increase in the electrode resistance. A too low proportion of the binder makes it difficult for the adhesive power with the current collector, the active material and the conductive auxiliary agent to be kept, and causes electrode exfoliation in some cases. From the above points, the content of the conductive auxiliary agent in the conductive auxiliary agent is preferably 1 to 10% by mass; and the content of the binder in the active material layer is preferably 1 to 10% by mass.

As the positive electrode current collector, aluminum, stainless steels, nickel, titanium and alloys thereof can be used. The shape thereof includes foils, flat plates and mesh forms. Particularly aluminum foils can suitably be used.

The porosity of the positive electrode active material layer (not including the current collector) is preferably 10 to 30%, and more preferably 20 to 25%. When the porosity of the positive electrode active material layer is made to be in the above values, it is preferable because the discharge capacity in use at a high discharge rate is improved.

(Electrolyte Solution)

As an electrolyte solution, there can be used a nonaqueous electrolyte solution in which a lithium salt is dissolved in one or two or more nonaqueous solvents.

The nonaqueous solvent includes cyclic carbonates such as ethylene carbonate (EC), propylene carbonate (PC), butylene carbonate (BC) and vinylene carbonate (VC); chain carbonates such as dimethyl carbonate (DMC), diethyl carbonate (DEC), ethyl methyl carbonate (EMC) and dipropyl carbonate (DPC); aliphatic carbonate esters such as methyl formate, methyl acetate and ethyl propionate; γ-lactones such as γ-butyrolactone; chain ethers such as 1,2-ethoxyethane (DEE) and ethoxymethoxyethane (EME); and cyclic ethers such as tetrahydrofuran and 2-methyltetrahydrofuran. These nonaqueous solvents can be used singly or as a mixture of two or more.

The lithium salt to be dissolved in the nonaqueous solvent is not especially limited, but examples thereof include LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, and lithium bisoxalatoborate. These lithium salts can be used singly or as a combination of two or more. Further as a nonaqueous electrolyte, a polymer component may be contained. The concentration of the lithium salt can be established in the range of 0.8 to 1.2 mol/L, and 0.9 to 1.1 mol/L is preferable.

(Additives)

It is preferable that the electrolyte solution contain compounds to be usually used as additives for nonaqueous electrolyte solutions. Examples thereof include carbonate compounds such as vinylene carbonate and fluoroethylene carbonate; acid anhydrides such as maleic anhydride; boron additives such as boronate esters; sulfite compounds such as ethylene sulfite; cyclic monosulfonate esters such as 1,3-propanesultone, 1,2-propanesultone, 1,4-butanesultone, 1,2-butanesultone, 1,3-butanesultone, 2,4-butanesultone and 1,3-pentanesultone; and cyclic disulfonate ester compounds such as methylene methanedisulfonate (1,5,2,4-dioxadithian-2,2,4,4-tetraoxide) and ethylene methanedisulfonate. These additives may be used singly or as a mixture of two or more. Particularly from the point of being capable of effectively forming a film on the positive electrode surface and improving the battery characteristics, cyclic sulfonate ester compounds are preferable, and cyclic disulfonate compounds are preferable.

The content of the additives in the electrolyte solution is, from the point of providing a sufficient addition effect while suppressing increases in the viscosity and resistance of the electrolyte solution, preferably 0.01 to 10% by mass, and more preferably 0.1 to 5% by mass. When the electrolyte solution contains a sufficient amount of cyclic sulfonate esters, the film can effectively be formed on the positive electrode surface and the battery characteristics can be improved. As the cyclic sulfonate ester compound, a cyclic disulfonate compound is preferably used.

(Separator)

As the separator, there can be used resin-made porous membranes, woven fabrics, nonwoven fabrics and the like. Examples of the resin constituting the porous membrane include polyolefin resins such as polypropylene and polyethylene, polyester resins, acryl resins, styrene resins and nylon resins. Particularly polyolefin microporous membranes are preferable because being excellent in the ion permeability, and the capability of physically separating a positive electrode and a negative electrode. Further as required, a layer containing inorganic particles may be formed on the separator, and the inorganic particles include those of insulative oxides, nitrides, sulfides, carbide and the like. Among these, it is preferable that TiO₂ or Al₂O₃ be contained.

(Outer Packaging Container)

As an outer packaging container, there can be used cases composed of flexible films, can cases and the like, and from the viewpoint of the weight reduction of batteries, flexible films are preferably used.

As the flexible film, a film having resin layers provided on front and back surfaces of a metal layer as a base material can be used. As the metal layer, there can be selected one having a barrier property including prevention of leakage of the electrolyte solution and infiltration of moisture from the outside, and aluminum, stainless steel or the like can be used. At least on one surface of the metal layer, a heat-fusible resin layer of a modified polyolefin or the like is provided. An outer packaging container is formed by making the heat-fusible resin layers of the flexible films to face each other and heat-fusing the circumference of a portion accommodating an electrode laminated body. On the surface of the outer package on the opposite side to a surface thereof on which the heat-fusible resin layer is formed, a resin layer of a nylon film, a polyester resin film or the like can be provided.

### EXAMPLES

### Example 1

A dispersion A was prepared by adding an acrylic binder to water, and sufficiently stirring and mixing the resultant. Here, the amount of the acrylic binder to be added was set to 1.7% by mass with respect to the water.

Next, a dispersion B was prepared by adding CMC (a sodium salt, manufactured by Nippon Paper Industries Co., Ltd., trade name: Sunrose MAC350HC) in the form of a powder to the dispersion A to be dissolved therein. Here, the amount of the CMC to be added was set to 1.2% by mass with respect to the water.

Then, a mixed powder of a negative electrode active material (coated natural graphite) and a conductive auxiliary agent (carbon black) and the dispersion B were mixed and kneaded. Here, a solid concentration (a concentration of components excluding the water) of the resultant mixture was set to 60% by mass.

Next, the solid concentration of the mixture was lowered to 45% by mass by adding water, and the resultant was further stirred to obtain a slurry to be used for forming a negative electrode active material layer.

The slurry was applied on a current collector (a copper foil), and the resultant was dried and pressed to obtain a negative electrode.

In the above-described process, a time taken from the step of mixing the mixed powder and the dispersion B to obtain the slurry was defined as a slurry preparation time. It is noted that a preparation time for the dispersion A was 0.5 hours or shorter (about 10 minutes). Completion of the slurry preparation was defined as a time point when there remained no aggregates of the materials and a prescribed viscosity (7000 cP) was obtained. It was determined visually, by using a grind gauge, whether or not the aggregates remained.

The thus obtained negative electrode was used to fabricate a lithium ion secondary battery as follows:

A slurry was prepared by dispersing, in a solvent, LiMn₂O₄ as a positive electrode active material, acetylene black as a conductive auxiliary agent, and polyvinylidene fluoride as a binder (positive electrode active material:conductive auxiliary agent:binder=85:5:10 (in mass ratio)), the thus obtained slurry was applied on a current collector (an aluminum foil), and the resultant was dried. The slurry was applied on another surface of the current collector in the same manner, the resultant was dried and pressed, and thus, a positive electrode including positive electrode active material layers formed on both the surfaces of the current collector was obtained.

A porous polypropylene (PP) film (having a thickness of 25 μm) obtained by dry process was used as a separator, and the negative electrode, the positive electrode and the negative electrode were laminated in the stated order through the separator to prepare an electrode laminate body. The thus obtained electrode laminated body was wrapped with an aluminum laminate film, an electrolyte solution was injected therein, and the laminate film was sealed. As the electrolyte solution, an electrolyte solution in which 1 mol/L of LiPF₆ was dissolved as a lithium salt in a mixed solvent of EC and DEC (EC:DEC volume ratio=3:7) was used.

Exfoliation strength of the negative electrode, contact resistance of the battery, a charge transfer resistance, and a capacity retention rate were measured by methods described later. The results are shown in Table 1.

### Comparative Example 1

A CMC aqueous solution (the amount ratio of CMC to water: 1.2% by mass) and a mixed powder prepared in the same manner as in Example 1 were mixed and kneaded. A solid concentration (a concentration of components excluding the water) of the mixture obtained here was set to 60% by mass.

Next, the solid concentration of the mixture was lowered to 50% by mass by adding water thereto, the resultant was stirred to lower the viscosity, and then, an SBR binder and additional water were added thereto, and the resultant was stirred to obtain a slurry to be used for forming a negative electrode active material layer. An ultimate solid concentration (a concentration of components excluding the water) of the slurry was set to 45% by mass. A CMC concentration and a binder concentration in the thus obtained slurry were respectively the same as those of Example 1.

In the same manner as in Example 1, the slurry was applied on a current collector (a copper foil), and the resultant was dried and pressed to obtain a negative electrode. Besides, a battery was obtained in the same manner as in Example 1.

In the above-described process, a time taken from the step of mixing the mixed powder and the CMC aqueous solution to obtain the slurry was defined as the slurry preparation time.

The exfoliation strength of the negative electrode, the contact resistance of the battery, the charge transfer resistance, and the capacity retention rate were measured by the methods described later. The results are shown in Table 1.

### Comparative Example 2

A slurry was prepared, a negative electrode was fabricated, and a battery was obtained in the same manner as in Comparative Example 1 except that an acrylic binder of the same type as that used in Example 1 was used instead of the SBR binder.

A time taken from the step of mixing the mixed powder and the CMC aqueous solution to obtain the slurry was defined as the slurry preparation time, and the exfoliation strength of the negative electrode, the contact resistance of the battery, the charge transfer resistance, and the capacity retention rate were measured by the methods described later. The results are shown in

Table 1.

### Comparative Example 3

An SBR binder was added to a CMC aqueous solution (the amount ratio of CMC to water: 1.2% by mass), and the resultant was sufficiently mixed. The amount of the SBR binder added here was set to 1.7% by mass with respect to the water.

Next, the thus obtained SBR binder dispersion and a mixed powder prepared in the same manner as in Example 1 were mixed and kneaded. Here, a solid concentration of the resultant mixture was set to 60% by mass.

Then, the solid concentration of the mixture was lowered to 45% by mass by adding water, and the resultant was further stirred to obtain a slurry to be used for forming a negative electrode active material layer. A CMC concentration and a binder concentration in the thus obtained slurry were respectively the same as those of Example 1. In the same manner as in Example 1, the slurry was applied on a current collector (a copper foil), and the resultant was dried and pressed to obtain a negative electrode. Besides, a battery was obtained in the same manner as in Example 1.

In the above-described process, a time taken from the step of mixing the mixed powder and the SBR binder dispersion to obtain the slurry was defined as the slurry preparation time.

The exfoliation strength of the negative electrode, the contact resistance of the battery, the charge transfer resistance, and the capacity retention rate were measured by the methods described later. The results are shown in Table 1.

(Contact Strength/Exfoliation Test)

The slurry of each example was applied on one surface of a copper foil in a basis weight of 10 mg/cm², the resultant was dried by heating at 60° C. for 5 minutes, and then at 110° C. for 5 minutes, and thus, a test electrode was fabricated. This electrode and an SUS plate were adhered to each other with a double-sided adhesive tape, and the resultant was subjected to a 180-degree exfoliation test (exfoliation width: 10 mm, exfoliation rate: 10 mm/min).

(Contact Resistance and Charge Transfer Resistance)

The obtained battery was subjected to alternating current impedance measurement, and the result was analyzed to calculate contact resistance and charge transfer resistance. The alternating current impedance measurement was performed at an environmental temperature of 25° C. in a battery state of an SOC (state of charge) of 100% (at a voltage of 4.2 V).

(Capacity Retention Rate/Cycle Test)

A cycle test was performed under the following charge and discharge conditions: CC-CV charge: upper limit voltage of 4.2 V, current of 1 C; CV time: 1.5 hours; CC discharge: lower limit voltage of 3.0 V, current of 1 C; and environmental temperature during charge and discharge cycles: 25° C. The capacity retention rate was defined as a ratio of the discharge capacity in the 500th cycle to the discharge capacity in the 1st cycle.

TABLE 1

| | | Slurry | | | Charge | |
|---|---|---|---|---|---|---|
| | | Prepa- | Exfoli- | Contact | Transfer | Capac- |
| | | ration | ation | Resis- | Resis- | ity |
| | | Time | Strength | tance | tance | Retention |
| | Binder | (hr) | (mN) | (mΩ) | (mΩ) | Rate (%) |
| Example 1 | Acrylic | 2.6 | 163 | 144 | 328 | 88 |
| Comparative | SBR | 4.6 | 130 | 150 | 350 | 85 |
| Example 1 | | | | | | |
| Comparative | Acrylic | 4.6 | 137 | 148 | 344 | 85 |
| Example 2 | | | | | | |
| Comparative | SBR | 2.6 | 78 | 163 | 402 | 38 |
| Example 3 | | | | | | |

### Comparison Between Example 1 and Comparative Example 1

In Comparative Example 1, the SBR binder (the rubber-based binder) is used as the binder, and the SBR binder is added after mixing the powder material containing the negative electrode active material with the CMC aqueous solution. As compared with such Comparative Example 1, according to Example 1 in which the acrylic binder is used as the binder and the binder dispersion is precedently prepared before adding the powder material (in particular, the binder and water are mixed before adding the CMC), the slurry preparation time can be shortened, and in addition, the exfoliation strength is high, the contact resistance and the charge transfer resistance are low, and the capacity retention rate is improved.

### Comparison Between Example 1 and Comparative Example 2

The acrylic-based binder is used in both Example 1 and Comparative Example 2, but the binder is added, in Comparative Example 2, after mixing the powder material containing the negative electrode active material with the CMC aqueous solution. As compared with such Comparative Example 2, according to Example 1 in which the binder dispersion is precedently prepared before adding the powder material (in particular, the binder and water are mixed before adding the CMC), the slurry preparation time can be shortened, the exfoliation strength is high, the contact resistance and the charge transfer resistance are low, and the capacity retention rate is improved.

### Comparison Between Example 1 and Comparative Example 3

In Comparative Example 3, the SBR binder (the rubber-based binder) is used as the binder, and the SBR binder is mixed with the CMC aqueous solution, and then, the resultant mixture is mixed with the powder material containing the negative electrode active material. As compared with such Comparative Example 3, according to Example 1 in which the acrylic binder is used as the binder (in particular, the binder dispersion is prepared by mixing the binder and water before adding the CMC), the exfoliation strength is high, the contact resistance and the charge transfer resistance are low, and the capacity retention rate is improved.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

The present application claims the right of priority based on Japanese Patent Application No. 2015-189916, filed on Sep. 28, 2015, the entire disclosure of which is incorporated herein by reference.

### REFERENCE SIGNS LIST

1 POSITIVE ELECTRODE ACTIVE MATERIAL LAYER
2 NEGATIVE ELECTRODE ACTIVE MATERIAL LAYER
3 POSITIVE ELECTRODE CURRENT COLLECTOR
4 NEGATIVE ELECTRODE CURRENT COLLECTOR
5 SEPARATOR
6 LAMINATE OUTER PACKAGE
7 LAMINATE OUTER PACKAGE
8 NEGATIVE ELECTRODE TAB
9 POSITIVE ELECTRODE TAB

1. A method for producing a negative electrode for a lithium ion secondary battery, the negative electrode comprising a current collector, and a negative electrode active material layer disposed on the current collector, the method comprising:
preparing a slurry comprising a negative electrode active material, a binder, a water-soluble polymeric thickener, and an aqueous solvent; and
forming a coating layer to be used as the negative electrode active material layer by applying the slurry on the current collector and drying the slurry for removing the aqueous solvent,
wherein said preparing the slurry comprises:
preparing a dispersion comprising the water-soluble polymeric thickener dissolved in the aqueous solvent and an acrylic binder dispersed as the binder; and
preparing and stirring a mixture comprising a powder material comprising the negative electrode active material, and the dispersion.

2. The method for producing a negative electrode for a lithium ion secondary battery, according to claim 1,
wherein said preparing the slurry comprises:
preparing a first dispersion comprising an acrylic binder dispersed in the aqueous solvent;
preparing, by adding the water-soluble polymeric thickener to the first dispersion, a second dispersion comprising the water-soluble polymeric thickener dissolved; and
preparing and stirring a mixture comprising a powder material comprising the negative electrode active material, and the second dispersion.

3. The production method according to claim 1,
wherein said preparing and stirring the mixture comprises:
stirring the mixture having a solid concentration of 50% by mass or higher and 70% by mass or lower; and
stirring the mixture with the solid concentration lowered to 40% by mass or higher and lower than 50% by mass.

4. The production method according to claim 1, wherein an amount of the acrylic binder to be added is 0.5 to 5% by mass with respect to the aqueous solvent.

5. The production method according to claim 1, wherein an amount of the water-soluble polymeric thickener to be added is 0.5 to 5% by mass with respect to the aqueous solvent.

6. The production method according to claim 1, wherein the water-soluble polymeric thickener comprises carboxymethyl cellulose.

7. The production method according to claim 6, wherein the carboxymethyl cellulose is a sodium salt.

8. The production method according to claim 1, wherein the negative electrode active material is a carbonaceous material.

9. The production method according to claim 8, wherein the carbonaceous material is a graphite-based material.

10. The production method according to claim 1, wherein the negative electrode active material has an average particle diameter of 2 to 40 μm.

11. The production method according to claim 1, wherein the powder material contains a conductive auxiliary agent.

12. The production method according to claim 11, wherein the conductive auxiliary agent is a carbonaceous material.
